(19) United States
(12) Patent Application Publication
(10) Pub. No.: US 2025/0053145 A1
(43) Pub. Date: Feb. 13, 2025

(54) SYSTEM ESTIMATOR WITH LOAD OPERATION SCHEDULING FOR AN ENERGY GENERATION AND/OR STORAGE SYSTEM

(71) Applicant: Enphase Energy, Inc., Petaluma, CA (US)

(72) Inventors: Sandeep PABBATHI, NagarKurnool (IN); Jinendra Kacharulal GUGALIYA, Bangalore (IN); Narasimha Swamy NELAKUDITI, Bangalore (IN)

(21) Appl. No.: 18/794,224

(22) Filed: Aug. 5, 2024

Related U.S. Application Data
(60) Provisional application No. 63/613,446, filed on Dec. 21, 2023.

(30) Foreign Application Priority Data
Aug. 11, 2023 (IN) 202311054160

(51) Int. Cl. G05B 15/02

(52) U.S. Cl. CPC G05B 15/02

(57) ABSTRACT

A method and apparatus for generating at least one operation schedule for at least one load connected to a system including an energy generation system, an energy storage system, or both. The method and apparatus initially estimate the system performance based upon system design and operational variables. A load operation schedule is adjusted to improve system performance and the adjusted load operation schedule is used to control at least one load.

### RELATED APPLICATION

This application claims benefit to Indian patent application Ser. No. 20/231,1054160 filed 11 Aug. 2023 entitled “System Estimator With Load Operation Scheduling For an Energy Generation and/or Storage System,” and claims benefit to U.S. Provisional Patent Application Ser. No. 63/613,446 filed 21 Dec. 2023 entitled “System Estimator With Load Operation Scheduling For an Energy Generation and/or Storage System,” which are hereby incorporated herein by reference in their entireties.

### BACKGROUND

### Field

Embodiments of the present invention generally relate to energy generation and/or storage systems and, in particular, to a system estimator with load operation scheduling for such systems.

### Description of the Related Art

A solar energy generation and storage system typically comprises a plurality of solar panels, one or more power inverters, a storage element and a service panel. The solar panels are arranged in an array and positioned to maximize solar exposure. Each solar panel or small groups of panels may be coupled to an inverter (so-called micro-inverters) or all the solar panels may be coupled to a single inverter. The inverter(s) convert the DC power produced by the solar panels into AC power. The AC power is coupled to the service panel for use by a facility (e.g., home or business), supplied to the power grid, and/or coupled to a storage element such that energy produced at one time is stored for use at a later time. Other energy generators having flexible capacity that is defined at installation include wind turbines arranged on a so-called wind farm. Storage elements may be one or more of batteries, fly wheels, hot fluid tank, hydrogen storage or the like. The most common storage element is a battery pack (i.e., a plurality of battery cells) having a bidirectional inverter coupled to the service panel to supply the batteries with DC power as well as allow the batteries to discharge through the inverter to supply AC power to the facility when needed.

Prospective purchasers of a solar energy generation and storage systems typically begin the process by meeting with a system installer and having the installer perform a site survey. The installer manually estimates the potential capacity of the required system by visiting the site where the installation is planned, measuring the space available, determining the amount of sunshine available based on the direction the solar panels will be exposed to the sun, estimating the capacity of the solar power generation available, and estimating the amount of energy storage that is commensurate with the amount of energy to be generated. Such meetings and surveys are time consuming and form an inefficient use of the purchaser's and installer's time. Especially when the prospective purchaser is merely exploring the possibility of making a purchase.

In some instances, a system may be tasked to power large loads such as charge an electric vehicle and/or power a heat pump. These tasks can be taxing on an energy generation and storage system because of the amount of energy they require at specific times of the day, e.g., end of the workday. The end of a traditional workday results in the vehicle returning to the garage for charging in addition to the residents requiring heating and/or cooling. Such energy consumption can be taxing on the performance of a solar energy generation and storage system. Typically, when designing a system, large loads are modeled as being used at all times which may result in an incorrect system design.

Therefore, there is a need for a system estimator that takes into consideration load scheduling for an energy generation and/or storage system that may be optimized to power loads such as charge an electric vehicle and/or power a heat pump.

### BRIEF DESCRIPTION OF THE DRAWINGS

So that the manner in which the above recited features of the present invention can be understood in detail, a particular description of the invention, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of energy generation and storage system having one or more load scheduling parameters that are to be determined in accordance with at least one embodiment of the invention;

FIG. 2 depicts a block diagram of a computer system supporting an energy generation and/or storage system estimator in accordance with an embodiment of the invention;

FIG. 3 depicts a functional block diagram of a system estimator in accordance with an embodiment of the invention;

FIG. 4 depicts a flow diagram of a method of operation of the system estimator of FIG. 3 in accordance with at least one embodiment of the invention;

FIG. 5 depicts graphs of input and output information from the system estimator in accordance with at least one embodiment of the invention; and

FIG. 6 depicts benchmark tables showing improvement in system operation through the use of load schedules in accordance with at least one embodiment of the invention.

### DETAILED DESCRIPTION

Embodiments of the present invention comprise apparatus and methods for determining at least one load schedule for an energy generation and/or energy storage system. Various embodiments utilize both operational variables and design variables regarding the energy generation and/or storage system to determine one or more system parameters (e.g., operational schedules for large loads such as, but not limited to, electric vehicle (EV) charging, heat pump operation, etc.). The one or more schedules may be optimized to enhance the operation of the overall energy generation and/or storage system over long periods of time (e.g., 25 years). In some embodiments, optimization is performed to minimize charges from the electric utility.

Embodiments of the invention utilize a web page as an interface to a user. The web page facilitates data input of the design and operational variables. Design variables may include, but are not limited to, solar panel type, inverter type, battery type, degradation factors for energy production and/or storage, solar panel orientation, number of solar panels, number of batteries, and the like. Operational variables include, but are not limited to, electrical power tariff type, capability of charging from the power grid, capability of discharging to the power grid, reserve state-of-charge (SOC), EV and heat pump ratings, EV charge cycle, heat pump recirculation operation, other large load operational parameters, and the like. Embodiments of the invention analyze the design and operational parameters to produce one or more load scheduling parameters that are used to provide improved, overall system performance.

In some embodiments, the solar energy generation and/or storage system is designed using a capacity estimator similar to the estimator described in commonly assigned U.S. patent application publication number 2021/0399547, filed 18 Jun. 2021, entitled “Capacity Estimator for an Energy Generation and/or Storage System,” which is hereby incorporated herein by reference in its entirety. The capacity estimator may be useful in creating and supplying the design variables to embodiments of the present invention without requiring a user to input the variables, e.g., access the information from a database. In some embodiments, the capacity estimator may be a portion of various embodiments of the present invention such that a design may be produced and the operational variables optimized to enhance system operation.

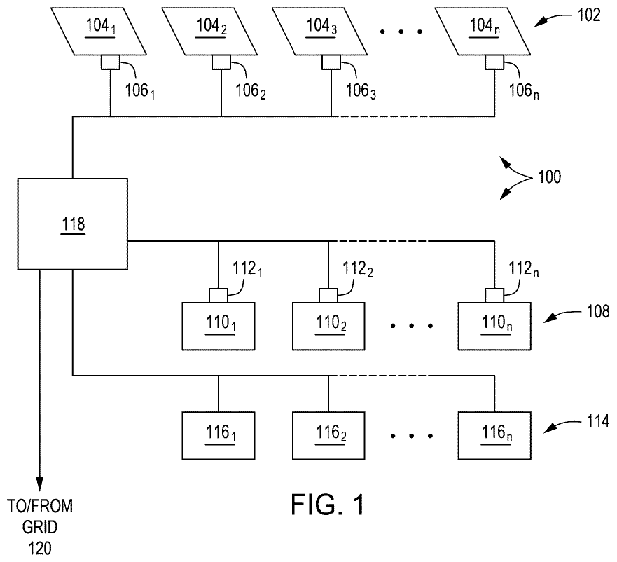

FIG. 1 depicts a block diagram of solar energy generation and storage system 100 having one or more system parameters that are determined and used for improved system performance in accordance with at least one embodiment of the invention. The system 100 comprises a plurality of distributed generators 102 (e.g., solar panels 104₁, 104₂, 104₃, . . . 104n coupled to inverters 106₁, 106₂, 106₃, . . . 106ₙ), storage 108 (e.g., batteries 110₁, 110₂, . . . 110n coupled to bidirectional inverters 112₁, 112₂, . . . 112ₙ), and a service panel 118 through which the distributed generator 102 is coupled to the storage 108. The service panel 118 is also coupled to a plurality of loads 114 represented by loads 116₁, 116₂, . . . 116n. The loads 114, in a residential application, may comprise washer, dryer, refrigerator, air conditioner, hot water heater, electric vehicle, heat pump, and/or any other electricity consuming device in the household. The loads 114, in an industrial application, may comprise electric motors, heating systems, air conditioning systems, refrigerators, freezers, and/or any other electricity consuming device generally used in an industrial setting. The service panel 118 may also be coupled to the power grid 120, such that, energy may be consumed from the grid 120 or sourced to the grid 120, as necessary. As shall be described below, embodiments of the present invention facilitate determining one or more load scheduling parameters to improve overall performance of the distributed generators 102 and/or storage 108 to power the loads 114.

Although FIG. 1 depicts a distributed generator 102 having a single solar panel coupled to a single inverter (i.e., micro-inverter), this depiction is not meant to limit the scope of the claimed invention. For example, embodiments of the invention may also be used with distributed generators having a plurality or more solar panels coupled to one or more inventers. Furthermore, distributed generators may include other forms of energy generation such as wind turbines arranged on a so-called “wind farm.” Similarly, energy storage in a battery-based storage system is described as an example of the type of storage used in embodiments of the invention; however, other forms of energy storage may be used such as fly wheel(s), hot fluid tank(s), hydrogen storage system(s), pressurized gas storage system(s), pumped storage hydropower, fuel cells, or the like.

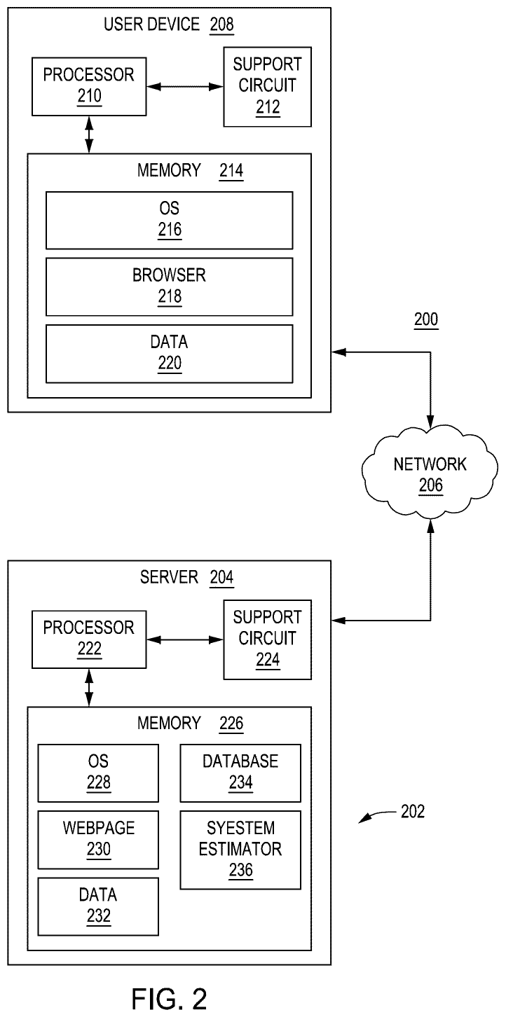

FIG. 2 depicts a block diagram of a computer system 200 supporting an energy generation and/or storage system estimator 202 in accordance with an embodiment of the invention. The computer system 200 comprises a server 204, a computer network 206 (e.g., Internet) and at least one user device 208 (e.g., mobile phone, digital assistant, computer, or any other device capable of displaying a web page). In operation, the user device 208 accesses at least one web page from the server 204 and displays the at least one web page for user interaction. The server 204, when executing specific software, enables the general-purposes server to operate as a specific-purpose device. Specifically, the server operates as a system estimator 202 to determine and/or optimize one or more operational parameters to display to a user on the user device in response to user data entered into fields on the web page. The parameters may also be used by the computer system 200 to control functions of the energy generator and/or storage system 100.

The user device 208 comprises at least one processor 210, support circuits 212 and memory 214. The at least one processor 210 may be any form of processor or combination of processors including, but not limited to, central processing units, microprocessors, microcontrollers, field programmable gate arrays, graphics processing units, and the like. The support circuits 212 may comprise well-known circuits and devices facilitating functionality of the processor(s). The support circuits 212 may comprise one or more of, or a combination of, power supplies, clock circuits, communications circuits, cache, and/or the like.

The memory 214 comprises one or more forms of non-transitory computer readable media including one or more of, or any combination of, read-only memory or random-access memory. The memory 214 stores software and data including, for example, an operating system (OS) 216, a browser 218, and data 210. The operating system 216 may be any form of operating system such as, for example, Apple IOS, Microsoft Windows, Apple macOS, Linux, Android or the like. The browser 218 may be any software that, when executed by the processor(s) 210, is capable of displaying and enabling user interaction with a web page. Such browsers 218 include, but are not limited to, Explorer, Safari, Chrome, Edge, Firefox or the like. The data 220 may include a web page, or portion thereof, data used by a web page, data entered by a user into fields within a web page and/or any other data used by the browser 218 to display and facilitate use interaction with a web page.

The server 204 comprises at least one processor 222, support circuits 224 and memory 226. The at least one processor 222 may be any form of processor or combination of processors including, but not limited to, central processing units, microprocessors, microcontrollers, field programmable gate arrays, graphics processing units, and the like. The support circuits 224 may comprise well-known circuits and devices facilitating functionality of the processor(s). The support circuits 224 comprise one or more of, or a combination of, power supplies, clock circuits, communications circuits, cache, and/or the like.

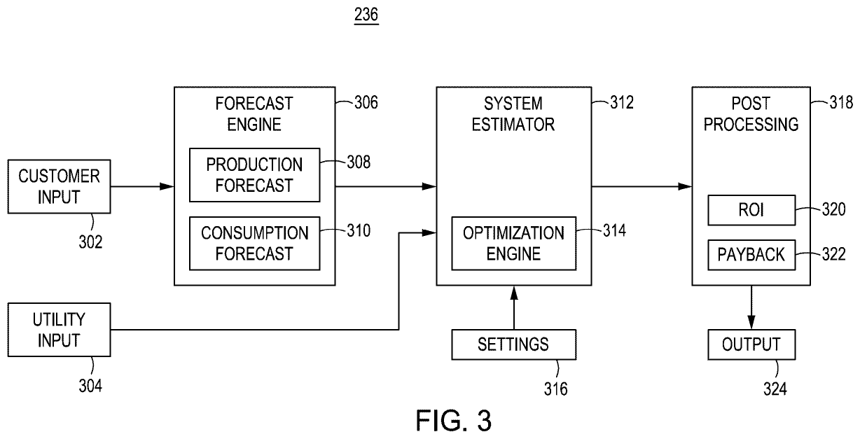

The memory 226 comprises one or more non-transitory computer readable media including one or more of, or any combination of, read-only memory or random-access memory. The memory 226 stores software and data including, for example, an operating system (OS) 228, a web page 230, data 232, a database 234 and capacity estimator software 236. The operating system 228 may be any form of operating system such as, for example, Apple IOS, Microsoft Windows, Apple macOS, Linux, Android or the like. The web page 230 is a web page that is accessible to the browser 218 of the at least one user device 208 to facilitate use of the system estimator 202 as shall be described in detail with respect to FIGS. 3 through 6 below. The data 220 may include data entered by a user into fields within a web page and/or any other data used by the server 204 to facilitate use of the web page. The database 234 contains data to facilitate determinations made by the system estimator software 236. This data may include, but is not limited to, information entered by a system owner (or prospective system owner) and information from a utility. Information from a system owner may include system design variables (such as solar panel types, inverter types, battery types, degradation factors for solar and storage production, direction of the solar panels, number of batteries and number of solar panels, etc.) and system operational variables such as utility tariff type, charge to grid, discharge to grid, reserve SOC, special load variables, etc.) The special loads may include electric vehicles and heat pumps such that the special load variables include electric vehicle ratings, electric vehicle charging cycle, heat pump circulator parameters, etc. Utility information may include power export limits (PEL) and power import limits (PIL). The database 234 may be locally stored at the server 204 or may be remotely stored on another server or servers and accessed via the network 206.

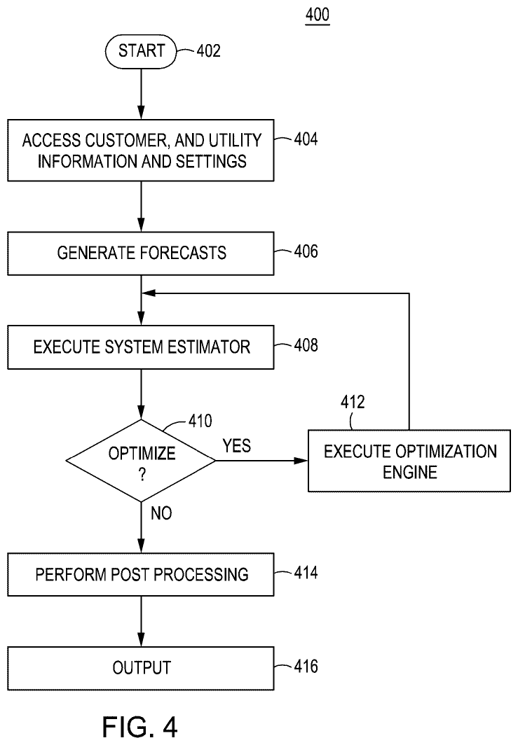

The server 204, when executing the system estimator software 236, is transformed from a general-purpose device into a specific-purpose device. i.e., transformed into the system estimator 202. The system estimator software 236, when executed, enables at least one user device 208 to access and interact with the web page 230. The system estimator software operation shall be described with respect to FIG. 4.

The computer system 200 may operate in conjunction with a communications manager as described in commonly assigned U.S. patent application Ser. No. 17/345,547, filed 11 Jun. 2021, entitled “Method and Apparatus for Communicating Information Regarding Distributed Generator Systems,” which is hereby incorporated by reference herein in its entirety. The communications manager facilitates communications amongst stakeholders (e.g., consumers, installers, vendors, etc.) involved in the design, development, purchase, installation, monitoring and maintenance of a distributed energy generation system.

FIG. 3 depicts a functional block diagram of the operation of the system estimator software 236 when executed by the server of FIG. 2 in accordance with at least one embodiment of the invention. The system estimator software 236 uses as its inputs: customer inputs 302, utility inputs 304 and various settings 316.

The customer (user) input 302 includes customer related information such as, but not limited to, system location, energy consumption history, load ratings and preferred operating period window for the loads, etc. In one embodiment, information regarding loads is typically limited to large energy consuming loads such as, but not limited to, information about electric vehicle(s) that are charged at the facility and/or heat pump(s) used to heat/cool the facility.

The customer information is processed by a forecast engine 306 to produces a production forecast 308, e.g., representing amounts of energy over time that the energy system is expected to produce, and a consumption forecast 310, e.g., representing amounts of energy over time that the energy system is expected to consume. These forecasts 308, 310 along with utility information 304 (e.g., utility tariffs for both imported and exported energy over time) and various system settings 316 are coupled to a system estimator 312 where operation of the energy system is estimated over a period of time (e.g., 25 years) based upon the various inputs. The variables used in the computation may be optimized using an optimization engine 314 to optimize one or more system parameters to achieve a particular goal (e.g., minimizing charges from the utility).

Various post processing functions 318 may be performed to determine return on investment (ROI) 320 and/or payback periods 322. Output 324 comprises a schedule of variable parameters that are to be used to enhance the operation of the system. In one embodiment, the output 324 is a schedule of when to operate certain loads to minimize charges from the utility, i.e., optimize the use of certain loads to minimize the cost of energy received from the utility. In one particular embodiment, the schedule indicates when to charge an EV and/or when to operate a heat pump circulator.

FIG. 4 depicts a flow diagram of a system estimator (202 of FIG. 2) for a solar energy generation and/or storage system (100 of FIG. 1) in accordance with an embodiment of the invention. As mentioned above, using the system estimator to estimate energy output of a solar energy system is a non-limiting example of a use for the estimator. Each block of the flow diagrams below may represent a module of code to execute and/or combinations of hardware and/or software configured to perform one or more processes described herein. Though illustrated in a particular order, the following figures are not meant to be so limiting. Any number of blocks may proceed in any order (including being omitted) and/or substantially simultaneously (i.e., within technical tolerances of processors, etc.) to perform the operations described herein.

FIG. 4 depicts a method 400 that is performed when the server 204 of FIG. 2 executes the system estimator software 236. The method 400 begins at 402 and proceeds to 404 where the method 400 accesses the customer, utility and setting information. This information may be entered and/or recalled from one or more databases.

The customer information includes the design and operational variables. Design variables may include, but are not limited to, solar panel type, inverter type, battery type, degradation factors for energy production and/or storage, solar panel orientation, number of solar panels, number of batteries, and the like. Operational variables include, but are not limited to, electrical power tariff type, capability of charging from the power grid, capability of discharging to the power grid, reserve state-of-charge (SOC), EV and heat pump ratings, EV charge cycle, heat pump circulator operation, other large load operational parameters, and the like.

The utility information includes utility grid operator tariffs based on the location of the customer, e.g., the amount a utility pays to purchase exported power from a customer and the amount the utility charges for supplying power to the customer. Net Energy Metering (NEM) or Net Billing Tariff (NBT) are utility billing mechanisms designed to incentivize the adoption of distributed energy resources (DERs). NEM allows customers to sell their surplus electricity to the utility at a defined value, typically set at the going rate of retail electricity. These purchases take the form of monthly bill credits that allow solar consumers to significantly reduce their annual electricity costs, which in turn enables them to see financial benefits from their system, all of which encourages adoption of more clean, distributed energy. The details of NEM rates across the country vary by jurisdiction and utility. Rates may be fixed or vary throughout a day depending on expected energy demand. NEM 3.0 has a tariff structure that varies with time of day (e.g., each hour) as well as from month to month through the year to account for seasonal changes in demand. The system estimator may utilize a projection of tariff data over an extended period representing the expected life of the energy generation resources, e.g., 25 years.

The settings information may include, but it not limited to, cost of equipment (e.g., inverter cost, panel cost, battery cost, etc.), interest rate, tax incentives and the like. These settings may be used to compute payback time frame and return on investment.

At 406, the method 400 uses the customer information to generate a production forecast (i.e., amount of energy produced per unit of time) and a consumption forecast (i.e., amount of energy consumed per unit of time). In one embodiment, the forecasts are computed each hour over a 25 year period. Based on solar irradiance data received from the National Weather Service (NWS), production is forecasted for the selected number of solar panels. In one embodiment, an artificial intelligence model in the system identifies nearby houses and trees, which affect the insolation received by panels. This provides a provision to enable the system estimator to simulate shading of the solar panels. The forecasted production is used to also estimate a battery schedule for the selected settings. There may also be a provision to select the number of panels, inverter type, PV degradation over time, and consumption escalation for upcoming years.

The consumption forecast is generally based upon the facility's historical consumption over a period of time. The forecast includes seasonal adjustments.

At 408, the method 400 executes the system estimator to determine an initial estimate of system performance. In one embodiment, the initial estimate of system performance is a cost of energy production for each increment of time (e.g., 1hour). This cost is calculated at a specific time by multiplying the amount of power imported from the grid (Pᵢₘₚ) times the cost of imported power (Cᵢₘₚ) and subtracting the amount of power exported to the grid (Pₑₓₚ) times the cost of exported power (Cₑₓₚ). This cost calculation at each time increment (t) may be represented by:

Cost(t)=(Pᵢₘₚ(t)×Cᵢₘₚ(t))−(Pₑₓₚ(t)×Cₑₓₚ(t)))

The total cost is found by summing the cost(t) at every time increment (e.g., 1 hour) over the time horizon period (e.g., 1 year or 8760 time increments). Various system variables that define the amount of power imported or exported in any given increment may be optimized to minimize the total cost. To do so, an objective function is applied to the cost calculation.

Various variable parameters define the amount of power that is imported or exported during any given time increment. These include, but are not limited to, maximum battery charge and discharge power, battery charge and discharge rate, battery state of charge, power import or export limits, etc. Also controllable are time periods for importing power, exporting power and storing/discharging battery power.

The variable parameters also include load related parameters. For example, the time period for operation of special loads such as, for example, but not limited to, a heat pump or electric vehicle (EV). For a heat pump, controllable variables include on/off periods, circulator pump speed, and the like. For an EV, variables include, but are not limited to, charge time, minimum and maximum EV charge power, initial EV state of charge (SOC), target EV SOC, current amount of EV power, and the like.

The controllable variables may be optimized to minimize to total cost, i.e., the variables are adjusted to improve system performance. At 410, the method queries whether optimization is to be executed. If the query is affirmatively answered, the method 400 proceeds to 412 to execute the optimization engine. The engine uses the objective function to adjust the controllable variables and run the system estimator again at 408. By iterating through the optimization engine at 412 and system estimator at 408, the total cost over the time period is minimized. Once the minimum is found, the query at 410 is negatively answered and the method 400 proceeds to 414.

At 414, the method 400 performs post processing of the cost information, system design information, and various variables. For example, post processing may include a payback period calculation and/or return on investment calculation. At 416, the method 400 outputs various system design parameters that enable the system to achieve the minimized total cost, such as, but not limited to, an optimal number of panels, optimal number of batteries, optimal panel facing direction, load operation schedules, and the like.

As for the load schedules, one of the variables that is controlled to minimize the total cost is a schedule of load utilization, e.g., the charge start time, duration and target charge for an EV to be powered from an electric vehicle supply equipment (EVSE) or a use start time, duration and speed for a heat pump. During each iteration through the system estimator, the load operation schedule(s) are adjusted to incrementally improve system performance (e.g., total cost).

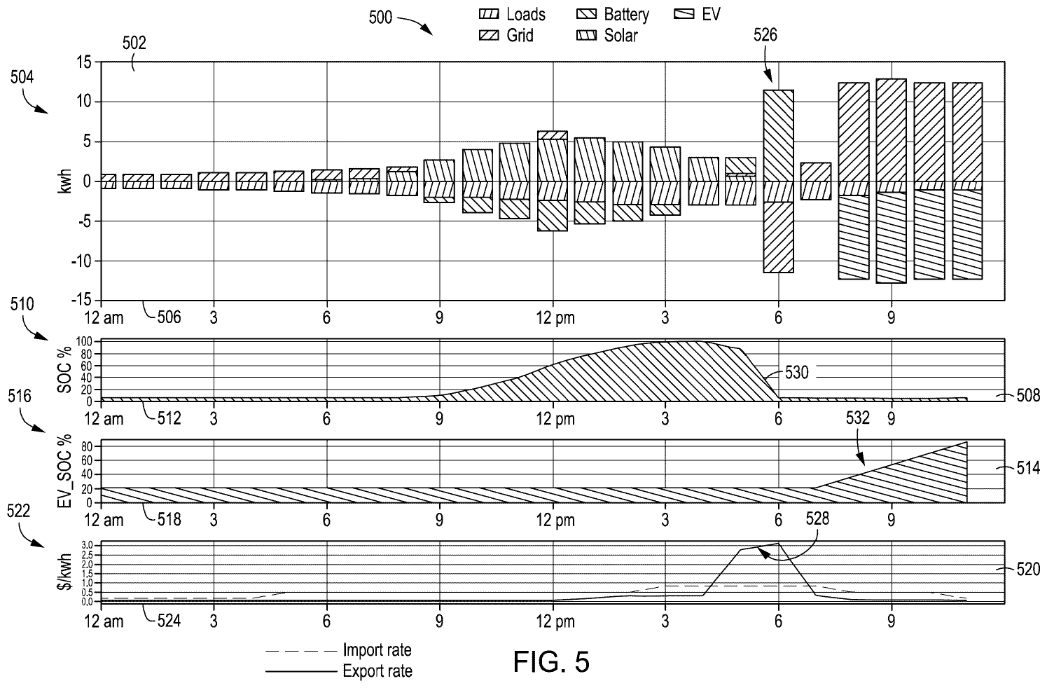

FIG. 5 depicts a set of graphs 500 of a particular scenario of system estimator operation over a 24-hour period. In this specific example, graph 502 has power as axis 504 and time as axis 506. Note that positive power is represented as power available for use (e.g., imported grid power, solar power, stored battery power), while negative power is power being used by loads, charging batteries, exported to the grid or charging an EV. Graph 508 has battery SOC percentage as axis 510 and time as axis 512, which indicates the charge state of the battery over time. Graph 514 has EV SOC percentage as axis 516 and time as axis 518, which indicates the charge state of the EV over time. Graph 520 has the utility tariff (import and export) as axis 522 and time as axis 524, which indicates the import/export cost of power over time.

The optimization process insures a minimum cost of power over the period (in this example, a 24 hour period). The timeline runs from 12 AM to 11 PM. In the early morning hours power is imported from the grid and consumed by the loads. As the sun rises around 6 AM, solar power is generated to supplant the imported grid power. When more than enough solar power is being generated to power the loads, the batteries are charged with solar power. In graph 510, the battery SOC percentage begins to rise until a 100% peak is reached in the mid-afternoon.

In late afternoon, as shown in graph 520, the export tariff begins rising at about 4 PM and peaks at 6 PM. Consequently, in view of this export tariff increase to incentivize power generator owners to sell power to the utility, the optimization process has scheduled the battery to cease charging near the peak tariff and send power to the grid (i.e., at 526, negative grid power and positive battery power in graph 502). To take advantage of the high export tariff (at 528), the battery is discharged to its minimum SOC percentage at 6 PM (at 530). At 7 PM, while the import tariff is relatively low (at 532), the system uses grid power to power the loads and to begin charging the EV.

In this example, the EV has a pre-established charging window with a start time of 4 PM and a duration until 11 PM. After optimization, the system estimator determines the lowest total cost results when the battery system is charged while the solar energy system is producing maximum power, sell all the battery power to the utility at the highest export tariff and use grid power after 7 PM to charge the EV at a relatively low tariff. Without optimization, the EV would have been charged with battery power starting at 4 PM resulting in less renewable power to be sold to the utility and high-cost power being used to charge the EV from the grid and battery.

The schedule for charging the EV starting at 7 PM is exported to the EVSE to control when the EVSE will charge the EV. This schedule may vary depending upon the optimization output that accommodates variations in tariffs, power production, and power consumption. However, the EV charging schedule is always constrained by the main constraint of when the EV is available for charging, e.g., between 4 PM and 11 PM, but starts charging at 4 PM.

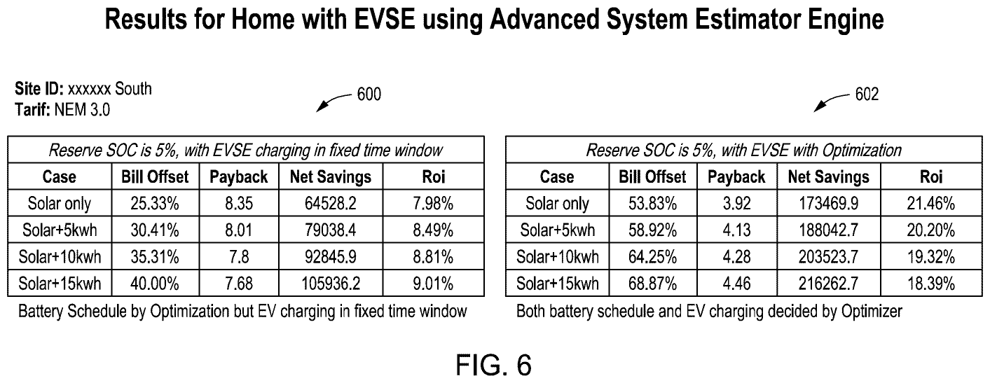

FIG. 6 depicts two tables 600 and 602 that compare system operation benchmarks when the optimized EVSE schedule is not used (table 600) and when it is used (table 602). Tables 600 and 602 contain four system designs: solar only, solar plus 5 kWh storage, solar plus 10 kWh storage and solar plus 15 kWh storage. For each system, the system estimator computes a number of system benchmarks: the bill offset, the payback period in years, the net cost savings in dollars and the return-on-investment percentage. For each of these benchmarks, the optimized system using an EVSE schedule has significantly improved results. The base case of a system with solar only has the payback period reduced by more than half (8.35 years to 3.92 years), a savings increase of nearly three-fold ($64K to $173K) and an ROI increase from 7.98% to 21.46%. Obviously, the use of optimized EVSE scheduling provides a significant technical and financial improvement over a fixed time window of EVSE operation.

In the foregoing example, the optimized load schedule was the EV charging schedule. Those skilled in the art will understand that this example may be extended to other loads, such as, but not limited to, heat pump, HVAC equipment, manufacturing equipment, etc. In the broadest sense, the system estimator may generate optimized operation schedules for any load to improve performance of the overall energy generation and/or storage system.

The foregoing description used a cost function to optimize system performance based upon minimizing the cost of energy; however, in other embodiments, the cost function may be optimized based on other objectives. For example, these other objectives may include, but are not limited to, energy independence (i.e., system uses a minimal amount of grid supplied energy), saving maximization, CO2 emission minimization, green energy use maximization, peak power demand minimization, and the like. The objectives may also be combined in a weighted manner. For example, a system may be optimized over multiple objectives such as saving maximization and energy independence using a weighted equation:

w1*saving maximization+w2*energy independence

where w1+w2=1 and w1 and w2 are weighting factors. An objective function may be applied to the weighted combination of objectives to achieve optimization across multiple objectives.

Here multiple examples have been given to illustrate various features and are not intended to be so limiting. Any one or more of the features may not be limited to the particular examples presented herein, regardless of any order, combination, or connections described. In fact, it should be understood that any combination of the features and/or elements described by way of example above are contemplated, including any variation or modification which is not enumerated, but capable of achieving the same. Unless otherwise stated, any one or more of the features may be combined in any order.

As above, figures are presented herein for illustrative purposes and are not meant to impose any structural limitations, unless otherwise specified. Various modifications to any of the structures shown in the figures are contemplated to be within the scope of the invention presented herein. The invention is not intended to be limited to any scope of claim language.

Where “coupling” or “connection” is used, unless otherwise specified, no limitation is implied that the coupling or connection be restricted to a physical coupling or connection and, instead, should be read to include communicative couplings, including wireless transmissions and protocols.

Any block, step, module, or otherwise described herein may represent one or more instructions which can be stored on a non-transitory computer readable media as software and/or performed by hardware. Any such block, module, step, or otherwise can be performed by various software and/or hardware combinations in a manner which may be automated, including the use of specialized hardware designed to achieve such a purpose. As above, any number of blocks, steps, or modules may be performed in any order or not at all, including substantially simultaneously, i.e., within tolerances of the systems executing the block, step, or module.

Where conditional language is used, including, but not limited to, “can,” “could,” “may” or “might,” it should be understood that the associated features or elements are not required. As such, where conditional language is used, the elements and/or features should be understood as being optionally present in at least some examples, and not necessarily conditioned upon anything, unless otherwise specified.

Where lists are enumerated in the alternative or conjunctive (e.g., one or more of A, B, and/or C), unless stated otherwise, it is understood to include one or more of each element, including any one or more combinations of any number of the enumerated elements (e.g. A, AB, AC, ABC, ABB, etc.). When “and/or” is used, it should be understood that the elements may be joined in the alternative or conjunctive.

While the foregoing is directed to embodiments of the present invention, other and further embodiments of the invention may be devised without departing from the basic scope thereof, and the scope thereof is determined by the claims that follow.

1. Apparatus for generating at least one operation schedule for at least one load connected to a system including an energy generation system, an energy storage system, or both comprising:
one or more processors coupled to one or more non-transitory computer readable media storing instructions thereon which, when executed by the one or more processors, cause the one or more processors to perform the operations comprising:
receiving data comprising system design variables and system operational variables;
determining, in view of the system design variables and system operational variables, an initial estimate of system performance;
generating a load operation schedule for at least one load;
adjusting the load operation schedule to improve system performance; and
output the adjusted operation schedule to control the at least one load.

2. The apparatus of claim 1, wherein the at least one load comprises an electric vehicle and/or heat pump.

3. The apparatus of claim 1, further comprising determining production and consumption forecasts using the system design variables and the system operational variables.

4. The apparatus of claim 1, wherein the system operation variables comprise tariffs for importing or exporting power.

5. The apparatus of claim 1, wherein the load operation schedule for an electric vehicle comprises a start time, a duration and a charging goal.

6. The apparatus of claim 1, wherein the load operation schedule for a heat pump comprises a start time, a duration and a circulator speed.

7. The apparatus of claim 1, wherein a measure of system performance is total cost of energy and adjusting further comprises applying an objective function to minimize the total cost of energy for the system.

8. The apparatus of claim 1, wherein a measure of system performance is at least one of total cost of energy, energy independence, saving maximization, CO2 emission minimization, green energy use maximization, peak power demand minimization, and adjusting further comprises applying an objective function to minimize the total cost of energy, energy independence, saving maximization, CO2 emission minimization, green energy use maximization, peak power demand minimization for the system.

9. A method for estimating capacity of a system including an energy generation system, an energy storage system or both comprising:
receiving data comprising system design variables and system operational variables;
determining, in view of the system design variables and system operational variables, an initial estimate of system performance;
generating a load operation schedule for at least one load;
adjusting the load operation schedule to improve system performance; and
output the adjusted operation schedule to control the at least one load.

10. The method of claim 9, wherein the at least one load comprises an electric vehicle and/or heat pump.

11. The method of claim 9, further comprising determining production and consumption forecasts using the system design variables and the system operational variables.

12. The method of claim 9, wherein the system operation variables comprise tariffs for importing or exporting power.

13. The method of claim 9, wherein the load operation schedule for an electric vehicle comprises a start time, a duration and a charging goal.

14. The method of claim 9, wherein the load operation schedule for a heat pump comprises a start time, a duration and a circulator speed.

15. The method of claim 9, wherein a measure of system performance is total cost of energy and adjusting further comprises applying an objective function to minimize the total cost of energy for the system.

16. The method of claim 9, wherein a measure of system performance is at least one of total cost of energy, energy independence, saving maximization, CO2 emission minimization, green energy use maximization, peak power demand minimization, and adjusting further comprises applying an objective function to minimize the total cost of energy, energy independence, saving maximization, CO2 emission minimization, green energy use maximization, peak power demand minimization for the system.

17. Apparatus for generating at least one operation schedule for at least one load connected to a system including an energy generation system, an energy storage system, or both comprising:
a forecast engine for generating production and consumption forecasts for the system;
a system estimator for using the production and consumption forecasts to generate a load operation schedule for at least one load; and
an optimization engine for adjusting the load operation schedule to improve system performance and for outputting the adjusted operation schedule to control the at least one load.

18. The apparatus of claim 17, wherein the at least one load comprises an electric vehicle and/or heat pump.

19. The apparatus of claim 17, further comprising determining production and consumption forecasts using the system design variables and the system operational variables.

20. The apparatus of claim 17, wherein a measure of system performance is at least one of total cost of energy, energy independence, saving maximization, CO2 emission minimization, green energy use maximization, peak power demand minimization, and adjusting further comprises applying an objective function to minimize the total cost of energy, energy independence, saving maximization, CO2 emission minimization, green energy use maximization, peak power demand minimization for the system.
